(19) United States
(12) Patent Application Publication
(10) Pub. No.: US 2020/0097950 A1
(43) Pub. Date: Mar. 26, 2020

(54) PRIVILEGED ENTITY CONSENSUS FOR DIGITAL ASSET CREATION

(71) Applicant: CA, Inc., New York, NY (US)

(72) Inventor: David Matthew Thompson, Louisville, CO (US)

(21) Appl. No.: 16/136,516

(22) Filed: Sep. 20, 2018

(51) Int. Cl. G06Q 20/36; G06Q 20/14; G07F 15/00; H04L 9/06

(52) U.S. Cl. CPC G06Q 20/3672; H04L 9/0637; G07F 15/003; G06Q 20/145

(57) ABSTRACT

Embodiments of the present invention provide techniques for generating digital tokens corresponding to determined generated real-world assets in a consensus-based authorization framework. In various embodiments, a client device coupled to a real-world asset generating device can determine that a real-world asset has been generated, and based on the determination, generate a request transaction for a digital token corresponding to the determined generated real-world asset. The request can be stored on a distributed ledger so that privileged entities can determine that the request is pending approval. Privileged client devices associated with the privileged entities can then generate approval transactions for generating the digital token corresponding to the determined generated real-world asset. A smart contract stored on the blockchain can determine that each of the privileged entities have authorized the generation of the digital token so that the smart contract can generate the new token, and issue the token to the client device or a public key associated with the client device.

### BACKGROUND

Distributed ledger technology generally closes what is referenced as the “trust gap,” whereby distributed nodes (i.e., computers) can programmatically work together, collectively, to provide a service that trusted third-parties have traditionally provided; that is, serving as a trusted entity or, in other words, an intermediary between counterparties of a transaction.

The introduction of distributed ledger technologies has opened a Pandora's box to a plethora of technical advancements in various industries. One particularly unique implementation of distributed ledger technologies relates to the tokenization of real-world assets. On a high level, the tokenization of a real-world asset generally requires the assignment of a unique identifier (e.g., a token) to a quantifiable asset that exists in the real world. Real world assets can include goods, real-estate, currency, or even electricity, among other things. The idea of tokenizing real-world assets opens the door to a wide variety of potential solutions applicable to trade, auditing, tracking, and more.

### SUMMARY

In conventional distributed ledger systems, consensus protocols are generally associated with the validation of transactions being communicated throughout the distributed ledger network maintained by the nodes (e.g., computers) of the distributed ledger system. That is, each node maintains its own respective copy of the distributed ledger, which is continuously updated and verified by other nodes of the distributed ledger network. However, when applying the benefits of distributed ledger technology to the tokenization of real-world assets, there lacks a technical solution for determining whether or not the real-world asset actually exists.

The disclosed embodiments describe a distributed ledger system that enables the generation of digital assets (e.g., tokens) for measurable real-world assets in a decentralized, trusted and reliable manner. More specifically, systems and methods are disclosed relating to a distributed ledger-based system and methods relating to a consensus-based technique for the authorized generation of tokens associated with measurable real-world assets, such as renewable electricity by way of non-limiting example.

In some embodiments, a computing device (e.g., a node) is coupled to a real-world asset generating device. The real-world asset generating device can be adapted to measure quantifiable amounts of the real-world asset that is generates. By way of non-limiting example, a renewable energy generator can include a meter adapted to measure a defined amount of renewable energy (e.g., 1 kilowatt) generated by way of its renewable energy source (e.g., sun, wind, water). The computing device can, based on a determination that the defined amount of the real-world asset has been generated, generate a first transaction that includes a first request to generate a digital token asset that corresponds to the determined generated real-world asset. The computing device can electronically authorize the first transaction by employing a first unique key, such as a first private key, to digitally sign the first transaction. The computing device can then communicate the generated first transaction to one or more nodes of a distributed plurality of nodes that collectively maintain the distributed ledger.

In some other embodiments, a computing device (e.g., a node) can receive a first transaction, or a first transaction block including the first transaction, for storage onto a local copy of the distributed ledger maintained by the distributed plurality of nodes, whereby the distributed plurality of nodes includes the computing device. The first transaction can be digitally-signed with a first unique key associated with a real-world asset generating device, such as the renewable energy generator described in the above example. The first transaction can further include a first request to generate a digital token asset that corresponds to a real-world asset generated by the real-world asset generating device. The node can then receive one or more second transactions, or one or more second transaction blocks including the one or more second transactions, whereby each second transaction is digitally signed with one of a set of second unique keys that are each predefined as authorized for approving, among other requests, the first request. Each digitally-signed second transaction can also include a second request to approve the first request (e.g., of the first transaction). The computing device can, based on a determination that its local copy of the distributed ledger includes the set of digitally-signed second transactions, and that each second unique key of the set of second unique keys corresponds to one of the digitally-signed second transactions, generate the corresponding digital token asset.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is an exemplary system diagram of a distributed ledger network in accordance with some embodiments of the present invention;

FIG. 2 is an exemplary operating environment of a distributed ledger network, in accordance with some embodiments of the present invention;

FIG. 3 is a block diagram depicting an exemplary node of a distributed ledger network in accordance with some embodiments of the present invention;

FIG. 4 is a block diagram depicting a renewable energy generator, according to some embodiments of the present invention;

FIG. 5 is a block diagram depicting an unprivileged client device, in accordance with some embodiments of the present invention;

FIG. 6 is a block diagram depicting a privileged client device, in accordance with some embodiments of the present invention;

FIG. 7 is a flow diagram showing a method for generating a digital token asset, in accordance with some embodiments of the present invention;

FIG. 8 is a flow diagram showing a method for requesting the generation of a digital token asset, in accordance with some embodiments of the present invention; and

FIG. 9 is a block diagram of an exemplary computing environment suitable for use in implementing some embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In conventional distributed-ledger based systems, digital assets (e.g., tokens or cryptocurrencies) are generally created through processes known as proof of work or proof of authorization. In a proof of work-based system, a node (i.e., computer) participating in the distributed ledger network can generate new tokens by correctly guessing a “nonce” in order to earn the right to generate a new block for storage onto the distributed ledger, thereby also earning a reward that is typically associated with the generation or “minting” of new digital assets. Proof-of-work systems, while generally sufficient for creating a fair system in which all nodes can participate in the maintenance and securement of the distributed ledger, is known to be inefficient and not sufficient for a solution that requires a more regulated framework.

In a proof-of-authorization system, a group of nodes participating in the distributed ledger network can generate new digital assets simply by virtue of having the authorization to do so. That is, distributed ledger systems utilizing a proof-of-authorization framework merely requires nodes to be programmatically authorized to generate new digital assets. While such a system can be optimal for maintaining controlled issuance or generation of tokens, there still remains a problem relating to the determination of whether a digital asset truly exists in the real-world.

In various industries, computing devices can be coupled to electric, mechanical, or electro-mechanical devices that generate measured or measurable amounts of real-world assets. By way of a non-limiting example, the renewable energy sector is one industry that utilizes such devices. A renewable energy generator can generate electricity from a renewable energy source, such as the sun, wind, or running water, among other things. Renewable energy generators can include meters, that are adapted to measure real world assets (i.e., amounts of electricity) being generated by a renewable energy generator harnessing a renewable energy source. Renewable energy is one of many industries that can employ computing devices coupled to electric, mechanical, or a combination of both (each hereinafter referred to as electro-mechanical devices) to accurately measure quantifiable amounts of real-world assets being generated. In a perfect world, such devices may generally be relied upon to provide accurate measurements. If an absolute reliance on the accuracy of self-reported data is utilized for tokenizing measured real-world assets, such as renewable energy, a proof-of-authorization system could be utilized for tokenizing real-world assets. However, one of ordinary skill would appreciate that electro-mechanical devices, such as renewable energy generators, don't necessarily meet specification or, like any technology, is susceptible to failure or reporting of inaccurate data (e.g., measurements).

Embodiments of the present disclosure are directed to a consensus-based distributed ledger system that provides privileged entities, such as electric companies, regulators, renewable energy device auditors, and/or any other regulatory party involved in ecosystems associated with real-world asset generating devices and the real-world assets being generated thereby, the ability to electronically authorize the generation of a digital asset (hereinafter referred to as a “digital token”) that corresponds to a real-world generated asset. The digital tokens generated by way of the disclosed embodiments can be tracked on a distributed ledger, such as a blockchain. While the term “blockchain” is referenced herein the distributed ledger of a preferred embodiment, it is contemplated that other distributed ledgers can be employed in accordance with the described embodiments.

In more detail, embodiments of the present invention provide a consensus-based framework for generating digital tokens corresponding to real-world assets by first defining a set of privileged unique keys associated with privileged entities. The defined set of privileged unique keys provides a foundation where privileged entities must collectively authorize the generation of a requested digital token before the digital token can be generated. On the other hand, a requestor of a digital token corresponding to a generated real-world asset can be associated with a unique key that is not defined as privileged. The requestor can generate requests for a digital token, however, and once submitted, the request must be authorized by a determined consensus of the privileged entities by way of their privileged unique keys before the distributed ledger network can generate the digital token corresponding to the real-world asset. In this way, each regulatory party (e.g., electric companies, auditors, governmental agencies) can employ, via their computing devices, a corresponding privileged unique key to collectively vote on whether a requested digital token should be generated based on its corresponding role in the ecosystem. In various embodiments, a privileged entity's role can include determining whether a real-world asset generating device is properly up to specification, whether reporting data is accurate, whether local laws are being followed, and the like.

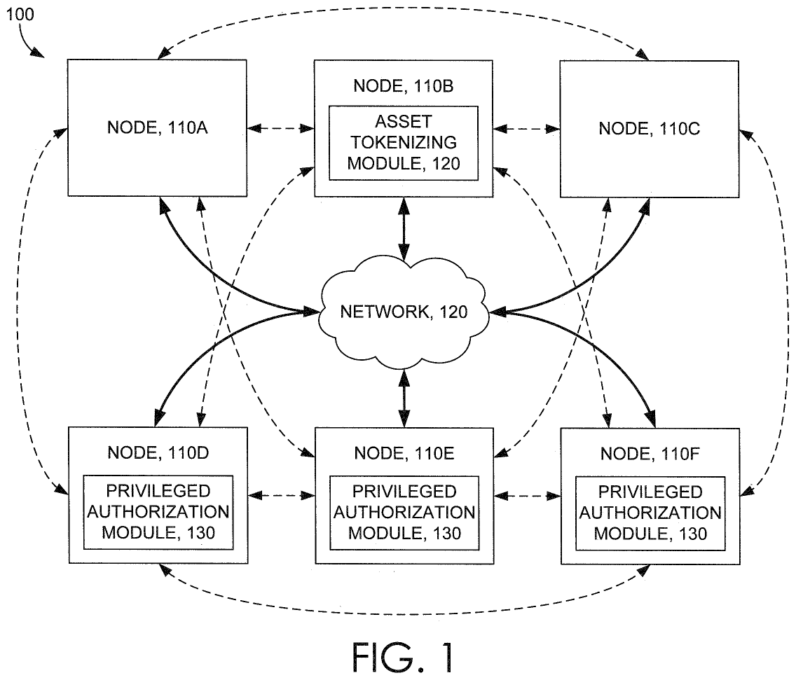

Turning now to FIG. 1, a schematic depiction is provided illustrating an exemplary distributed ledger network 100 in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

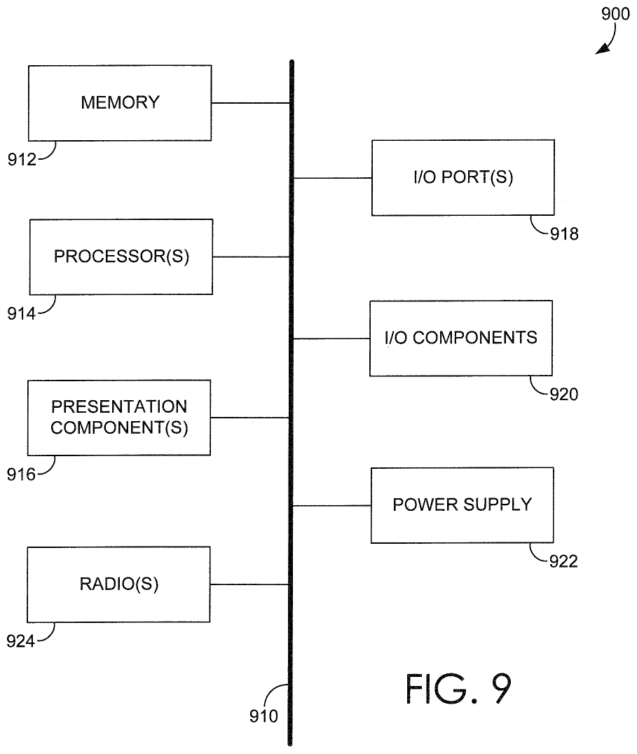

The distributed ledger network 100 depicted in FIG. 1 includes a plurality of nodes 110A-110F that are each in communication with one or more nodes 110A-110F over a network 120, such as the Internet, a LAN, a WAN, a telecommunications network, or the like. In accordance with the present disclosure, each node 110A-110F is a node of a distributed ledger network, whereby each node can be a hardware device and/or a component of a computing device later described in accordance with FIG. 9. In some embodiments, and preferably for public blockchain implementations, each node 110A-110F in the distributed ledger network 100 can operate as a peer to every other node 110A-110F of the distributed ledger network 110 such that no single node 110A-110F is more influential or powerful than any other node 110A-110F. Operations performed by nodes can include, among other things, validating transactions, verifying blocks of transactions, and adding records to an immutable database that is collectively maintained by the nodes 110A-110F.

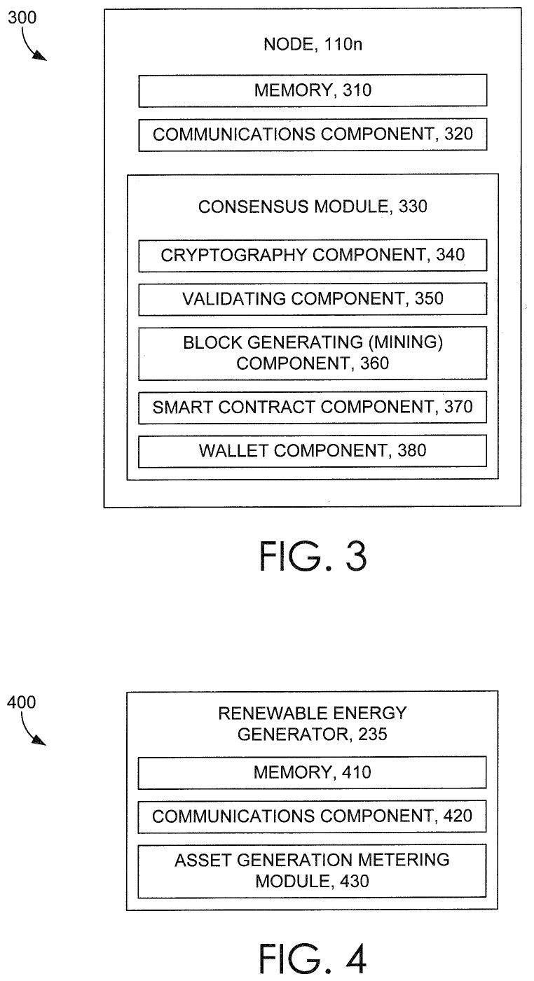

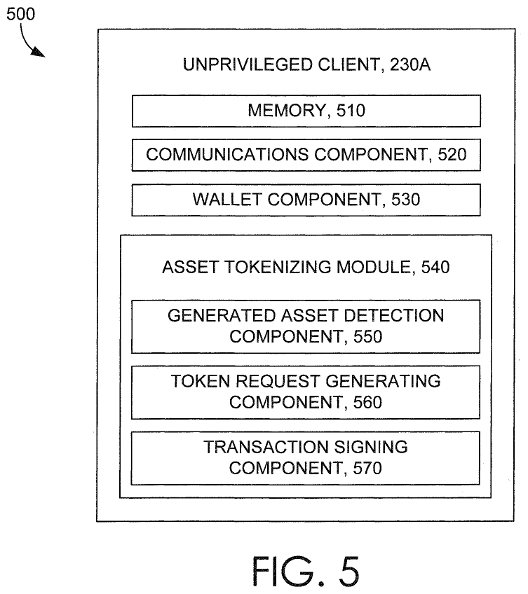

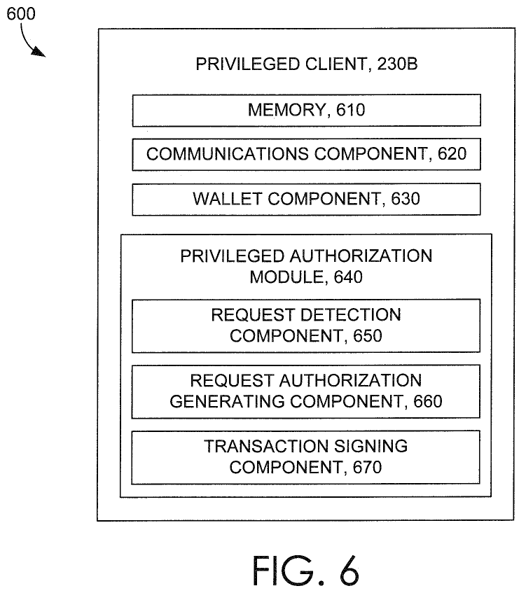

It is contemplated, however, that in some embodiments, a particular subset of the nodes, such as nodes 110B or 110D-110F can be specifically designated for performing more than the node operations generally described herein with respect to FIG. 3. In this regard, as opposed to embodiments where each node is a peer with other nodes, some embodiments can employ specially—“privileged nodes” or “unprivileged nodes” (preferably for private blockchains or ecosystems where centralization is not a concern) that perform more of the node operations generally described in accordance with FIG. 3. In some embodiments, and particularly for public blockchains where each node must be a peer with other nodes, client devices can be differently configured to facilitate the “privileged” or “unprivileged” operations, which will be later described in accordance with FIGS. 5-6.

In accordance with some embodiments described herein, the immutable database collectively maintained by the nodes 110A-110F is referenced herein as a blockchain. The blockchain maintained by the distributed ledger network 100 includes a plurality of records that is immutable by virtue of the distributed nature of the distributed ledger network 100, applied cryptography concepts, and a consensus module (not shown) that is independently included and operated by any number of nodes 110A-110F. While any node can generate a transaction to be added to the blockchain, the consensus module requires that the record be added to the blockchain only based on a determination that a consensus (e.g., greater than 50%) of the nodes 110A-110F has collectively validated the transaction. In this regard, while each node 110A-110F can independently store a copy of the blockchain, a transaction can only be added to the blockchain when a consensus to add the transaction has been reached by the nodes 110A-110F of the distributed ledger network 100.

In various embodiments, validation of a transaction is facilitated utilizing features of asymmetric key cryptography (i.e., public-private key pairs), among other things. In some aspects, as is commonly known in public blockchains (e.g., Bitcoin, Ethereum), a private key can be employed to generate one or more associated public keys, encrypt data that can only be decrypted by an associated public key, and/or digitally sign data or transactions. On the other hand, a public key can be employed to decrypt data encrypted by an associated private key, encrypt data that only the private key can decrypt, and/or digitally authenticate a digital signature generated by an associated private key. As public keys can be shared freely, public keys generally function as “wallet addresses” that are associated with a private key. In this regard, digital tokens or other units of value (e.g., Bitcoin, Ethereum) can be “transmitted” from one wallet address (i.e., a public key of a sender) to another wallet address (i.e., a public key of a receiver). In actuality, however, the transmission of a digital token or unit of value is not a physical transfer, but is represented as a record of transfer from one wallet address to another that, if validated, is recorded onto the blockchain. The transaction is not finalized (i.e., added to the blockchain), however, until the transfer is validated by a consensus of the nodes 110A-110F in the distributed ledger network 100.

To generate a transaction to transfer a digital token(s) or value, the owner of the sending wallet address must digitally sign the transaction with the private key associated with the sending wallet address. Nodes 110A-110F of the distributed ledger network 100 must independently determine that the transaction from the sending wallet address is valid by digitally authenticating the digital signature with the sending wallet address (i.e., the public key). The nodes 110A-110F (or designated nodes) must also independently determine, by referencing their independently-stored copy of the blockchain, that the sending wallet address is in fact associated with the digital token being transferred, or that the sending wallet address has sufficient liquidity (i.e., has a calculated aggregate value based on associated records in a local copy of the blockchain) to transfer the unit(s) of value. If a node in the distributed ledger network 100 determines that either of the foregoing conditions is not satisfied, the transaction is determined invalid by the node and the transaction is not passed on (e.g., communicated) to other nodes to which it is connected. On the other hand, if the node determines that both of the foregoing conditions are satisfied, the transaction is determined valid and the node passes on (e.g., communicates) the transaction, along with an indication that the node independently validated the transaction, to any other nodes 110A-110F to which it is connected. As the nodes 110A-110F in the distributed ledger network 100 are all directly or indirectly connected to one another, this validation process continues until the nodes collectively determine that a majority (i.e., consensus) has validated the transaction. The collective determination of consensus can be facilitated by virtue of each node maintaining a list of other nodes on the network (e.g., by I.P. address or other identifier) along with their respective determinations of transaction validity.

After a consensus of validity for a transaction has been reached by the nodes 110A-110F (or designated nodes), the transaction awaits confirmation (i.e., addition to the blockchain). As the nodes 110A-110F can be peers with each other, any node can participate in the process of adding the transaction to the blockchain. For purposes of background, the blockchain includes validated transactions that are grouped into a cryptographically chained series of blocks, whereby each block includes a subset of these transactions. Any node 110A-110F can perform the process of block generation, which can be implemented in a variety of ways based on a consensus algorithm implemented within its consensus module including, but not limited to, proof of work, proof of stake, proof of authority, practical Byzantine Fault Tolerance, or Federated Byzantine Agreements. As the aforementioned processes for block generation are generally known in the art, additional detail for these processes are not described herein. It is contemplated, however, that any implementation of block generation and consensus determination can be employed in accordance with the present disclosure. More importantly, as the general outcome of block generation is relatively similar among these implementations, the following description is provided irrespective of the block generation aspect of the consensus module.

To add a validated transaction to the blockchain, the transaction must first be included into a block that is being generated by one of the nodes 110A-110F and subsequently validated by a consensus of the nodes in the distributed ledger network 100. The transaction can be independently included into a block, or grouped together with other transactions, either of which are included within the purview of the present disclosure. Such implementations may vary, however, based on consensus module design and/or a block size (i.e., memory limitation) implemented or defined within in the consensus module operated by the nodes 110A-110F (or designated nodes). The node generating the block must also include, into the block it is generating, a cryptographic hash of the block most-recently added to the blockchain. Once generated in accordance with consensus rules defined within the consensus module, the node generating the block can send the generated block to any of the nodes to which it is connected.

The nodes receiving the generated block can then verify that the block includes one or more valid transactions, includes a hash value of the block most-recently added to the blockchain, and was generated in accordance with the defined consensus rules. Upon verifying the foregoing, the nodes can pass on (e.g., communicate) the verified block to its neighboring nodes (or neighboring designated nodes). In this way, similar to how a transaction is validated by a determined consensus of the distributed ledger network 100, the generated block including at least the transaction can be verified by another determined consensus of the nodes (or designated nodes). When a determination is made by a consensus of the nodes 110A-110F that a block is verified, the newly-verified block is added to the blockchain immediately subsequent to the previously-added block, the hash of the previously-added block being included in the newly-verified block. As such, each block is cryptographically “chained” to a previous block and a subsequent block. In other words, the cryptographic hashes facilitate maintenance of the order and accuracy of records included in the blockchain.

In some instances, if the same transaction is included into a block generated by different nodes and validated throughout the network within a substantially similar timeframe, the blocks can be temporarily confirmed leading up to a fork in the blockchain (e.g., two potential branches stemming from the main chain). The forked chain can be maintained by the nodes until a determination is made, by a consensus of the distributed ledger network 100, that one of the forks has a larger quantity of blocks than the other. Based on a subsequent determination that one of the forks is shorter than the other, the nodes can prune (e.g., delete) the shorter chain, and maintain the longer chain as the determinative blockchain.

In various embodiments, the blockchain is not necessarily limited to storing records relating to transfers of digital tokens or monetary value. In this regard, a record can include any type of electronic record, including but not limited to one or more transactions, smart contracts, electronic documents, requests, approval or denial of requests, metadata, images or other digital media, URIs, alphanumeric text, unique identifiers, I.P. addresses, timestamps, hashes of any of the foregoing, or references to any of the foregoing. Any of the foregoing examples can be viewed as being the subject of a transaction, or can be indirectly associated with a transaction. For instance, ownership of an asset stored in a medium other than the blockchain (e.g., a remote storage device, a cloud server, a database) can be referenced with a unique identifier. If the asset is a digital asset, a URI and/or hash of the digital asset can be the subject of the transaction. If the asset is a tangible asset, a unique identifier associated with the tangible asset can be the subject of the transaction. It is contemplated that any combination or alternative to the foregoing examples remain within the purview of the present disclosure.

With specific regard to smart contracts stored as records on the blockchain, a smart contract can include any algorithm that defines an action or event that is to be triggered based on a determination that one or more defined conditions precedent to the action or event have occurred. In various embodiments, a smart contract can be generated, transmitted, received, stored, validated, and/or verified by any node or computing device described in accordance with the present disclosure. It is further contemplated that a consensus module of each node or computing device in the distributed ledger network 100 is capable of interpreting and executing a Turing complete programming language, such as Solidity, by way of non-limiting example. It is further contemplated that in some embodiments, the blockchain itself is implemented based on the same programming language.

In various embodiments, smart contracts stored on the blockchain can be associated with a corresponding address, similar to that of a wallet address. The smart contract can be assigned a corresponding address by the distributed ledger network 100, or can be associated with a wallet address associated with one or more private keys. Counterparties associated with a smart contract can verify, via their respective computing devices in communication with one or more nodes of the distributed ledger network 100, that the smart contract has been immutably stored onto the blockchain based on a determined consensus of the nodes 110A-110F.

As smart contracts can be stored on the blockchain, each node can independently determine whether a smart contract's defined conditions precedent have occurred in order to verify that the terms of the smart contract have been met. In various embodiments, each node can determined occurrence of defined conditions precedent based on electronic information communicated thereto or retrieved thereby, or based on a determination that various transactions included in the blockchain meet the defined conditions precedent. The electronic information can include, among other things, another transaction addressed to or referencing the smart contract, data from one or more computing devices remote from the distributed ledger network 100, data from a website, data from a database, published news events, published weather events, or any other type of electronic information that can be transmitted to or accessed by a node via the network 120.

Each node can independently verify occurrence of the defined conditions precedent associated with a smart contract and, in turn, trigger the event or action associated with the smart contract. As each node has a verified unitary copy of the distributed ledger, it is generally understood that each node will have executed the smart contract based on the defined conditions precedent being determined met by the node. In various embodiments, the event or action can include the processing of a transaction (e.g., a processing of a transfer for digital tokens or value) that is held or locked until a determination that the conditions precedent have occurred, a generation of a new digital token(s), and/or a generation of a new transaction (e.g., transfer of a encumbered or newly generated digital token). In this regard, any digital asset that is encumbered or generated via the smart contract can be locked (e.g., held in escrow) by the smart contract until a determination of the defined conditions precedent has been made.

In accordance with the described embodiments, a smart contract can determine that a first transaction includes a request to generate a new digital token. The smart contract can include code or logic that defines a set of unique keys as being privileged or “authorized” to vote on the generation of the requested new digital token. When the node, employing the smart contract, determines that transactions on its local copy of the blockchain include the request and a defined consensus (e.g., a majority, all) of transactions that are signed with the privileged unique keys and authorizing the request, the smart contract can automatically generate the new digital token for association with a unique key associated with the request.

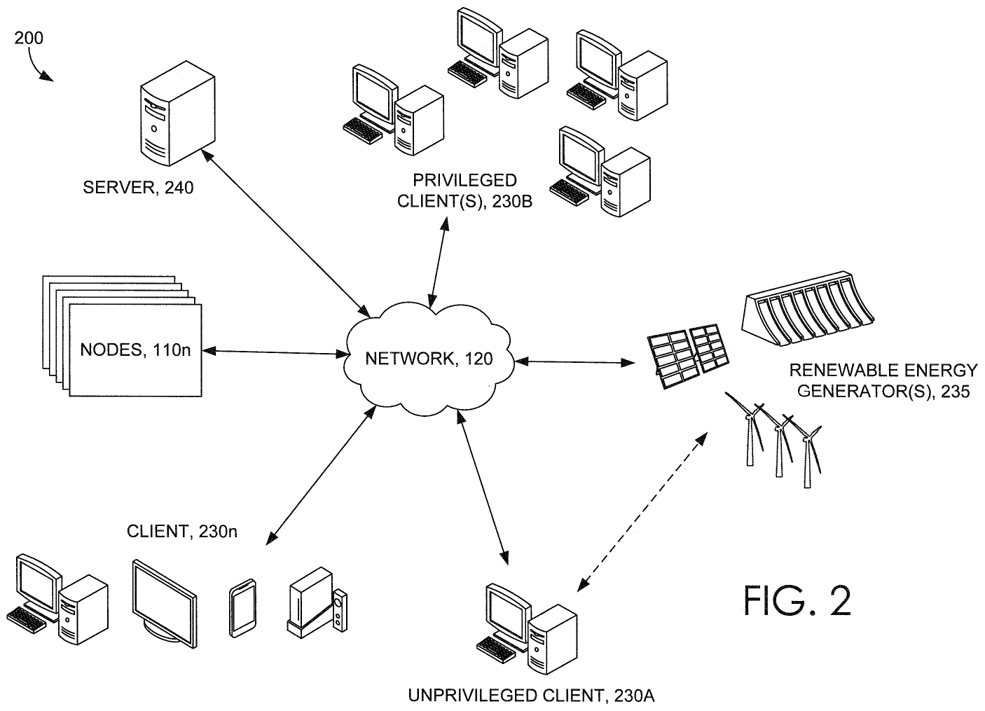

Referring now to FIG. 2, a schematic depiction is provided illustrating an exemplary system 200 in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 200 can include, among other things, a distributed ledger network 100 comprising a plurality of nodes 110n as described with reference to FIG. 1, each in direct or indirect communication with one another via a network 120. While the embodiments described herein generally relate to a public blockchain that includes a plurality of peer nodes, it is contemplated that the nodes 110n can include a subset of privileged and/or unprivileged nodes authorized to perform specifically-designated operations, such as request generation, request approval or denial, validation, verification, or block generation, among other things.

The system can also include one or more client devices, such as client 230, 230n. It is contemplated that any one or more nodes 110n can be a client 230, 230n, and one or more clients, 230, 230n can be a node in accordance with embodiments described herein. In this regard, nodes 110n and clients 230a, 230b, 230n can also include computing devices described herein in accordance with FIG. 9.

In one aspect, a client 230, 230n and can include the consensus module similarly included in other nodes 110n within the distributed ledger network 100. In another aspect, the client 230, 230n can generate transactions that can initially be validated locally, via the consensus module included therein, before the transaction is passed on to other nodes. In another aspect, a client 230, 230n can be in communication with one or more nodes 110n via the network 120, and can locally generate a transaction for communication via the network 120 to one or more nodes 110n that the client 230, 230n is in communication with. In this way, the one or more nodes 110n receiving the transaction directly or indirectly from the client 230, 230n can validate the transaction in accordance with the present disclosure.

In some aspects, any node 110n can operate as a node that includes the consensus module, and any client 230A, 230B, 230n can operate as a client device that can: transmit communications to one or more nodes 110n, generate transactions, and receive communications (e.g., transaction status, blockchain data) from one or more nodes 110n. For purposes of simplicity, the following description will reference a client 230A, 230B, 230n as a node 110n, though embodiments are not limited as such. In some embodiments, each client 230A, 230B, 230N can include a client application having at least one function for generating transactions for communication to any node of the distributed ledger network 110n. In this regard, each client 230A, 230B, 230N can be associated with a corresponding unique identifier (i.e., private key) for digitally signing transactions it generates, such that the transaction can be tied to (i.e., associated with) the entity associated with the client.

In various embodiments, a client device can include an unprivileged client 230A that is associated with an entity that can request the generation of a digital token associated with a real-world asset. The unprivileged client 230A can be coupled to one or more real-world asset generating devices, such as renewable energy generator 235 by way of example. A renewable energy generator 235 can include a set of solar panels, a set of hydropower turbines, a set of wind turbines, any other set of renewable energy generators, or any combination thereof. In various embodiments, a real-world asset generating device can include or be coupled to a monitoring device, capable of determining a quantifiable amount of the real-world asset being generated thereby. For example, renewable energy generator 235 can include or be coupled to an electricity meter for determining an amount of electricity being generated by renewable energy generator 235. In this regard, the unprivileged client 230A can determine when a defined amount (e.g., 1 kilowatt hour) of the real-world asset is generated, and based on the determination, generate a transaction, including a request to generate a corresponding digital token, that is digitally signed with a unique identifier (e.g., associated with the client 230A or associated with the real-world asset generating device). The unprivileged client 230A can then transmit the generated and digitally-signed transaction to any of the distributed nodes 110N for storage onto the blockchain.

In various embodiments, a client device can include a privileged client 230B associated with a privileged entity (e.g., a regulator, auditor, government agency, electric company). A privileged client 230B can be associated with a privileged unique identifier (e.g., private key) that is one of a plurality of known privileged unique identifiers. As will be described, a smart contract included in the nodes 110N can be configured to include code or logic to determine whether a transaction is digitally-signed with one of the known privileged unique identifiers, in order to determine whether a consensus of the privileged entities has approved or denied the generation of a new digital token subject to a request stored in another transaction on the blockchain.

In some embodiments, the system 200 can further include a server device, such as server 240. The server 240 can be in communication with one or more nodes 110n to send generated transactions to the one or more nodes 110n, request and receive transaction status information from the one or more nodes 110n, and/or request and receive blockchain data from the one or more nodes 110n, among other things. In some further embodiments, server 240 can include can include one or more computing devices, also described in accordance with FIG. 9, whereby the one or more computing devices include a consensus module to operate as a node 110n or a privileged node. Among other things, the server 240 can further provide one or more services, such as data storage services, web hosting services for one or more websites, user authentication services, certificate authentication services, backup services, data mining services, “cloud”-stored data or web search services, block explorer services, analytics services, and the like, including any combination thereof. In some embodiments, the server 240 can provide a third party voting service that can generate approval or denial transactions on behalf of various privileged entities (e.g., electric company, auditor, government agency) of the real-world asset ecosystem described herein. The server 240 can, among other things, store a set of rules that each privileged entity can define for analyzing requests for new token generation. The server 240 can receive one or more rules from each client device associated with an entity. The server device can also store therein a unique key (i.e., private key) associated with each privileged entity to generate digitally-signed transactions on the privileged entity's behalf. In this way, the server 240 can monitor the blockchain to determine whether a request to generate a token has been stored to the blockchain, and can generate for each privileged entity an approval or denial transaction corresponding to the request based on the privileged entity's defined set of rules.

Turning now to FIG. 3, a block diagram 300 is provided depicting an exemplary node 110n in accordance with the present disclosure. The node 110n depicted in FIG. 3 can include, among other things, a memory 310, a communications component 320, and a consensus module 330. The memory 310 can include any type of memory, such as a hardware storage device, random access memory (RAM), a cache, read-only memory (ROM), and the like, including any combination thereof. The memory 310 can be employed to store executable computer code that, when executed by one or more processors of the node 110n, perform operations defined and/or implemented within the consensus module described herein. The memory 310 can also be employed to store data communicated from other nodes 110n, clients 230a, 230b, 230n and/or servers 240, such as those described in accordance with FIG. 2. The communicated data stored in memory can include, among other things, transactions, one or more blocks of a blockchain, determinations of validity, determinations of authentication/verification, unique identifiers and/or IP addresses of one or more nodes 110n, and other types of electronic data not limited to the foregoing.

The communications component 320 can include any type of communications device that enables the node 110n to communicate with other nodes 110n, clients 230a, 230b, 230n and/or servers 240, such as those described in accordance with FIG. 2. Communications can be facilitated utilizing wired or wireless communications, and can employ any short or long-range communications technology including, but not limited to, LANs, WANs, Ethernet, the Internet, Wi-Fi, Bluetooth, NFC, optics (e.g., QR codes, Infrared), ZigBee, radio, RFIDs, and the like.

The consensus module 330 can include any number of components or subcomponents that, together with the memory 310 and communications component 320, enable the node 110n to operate as a peer in a distributed ledger network, such as distributed ledger network 100 described in accordance with FIG. 1. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

In various embodiments, cryptography component 340 can employ asymmetric cryptography (i.e., public-private key) to perform digital authentication and/or verification operations. By way of example, cryptography component 340 can determine whether a transaction submitted from a public key is digitally signed with a corresponding private key. As a digital signature from a public key can only be valid if digitally signed with the corresponding private key, the cryptography component 340 can be employed by the validating component 350 to verify that the transaction is valid with regards to the sender of the transaction. Without going into further detail, in further embodiments, the cryptography component 340 can generate hashes of data, such as transactions, transaction blocks, or passwords, among other things. Hashes can be employed by the validating component 350 to determine that the data has not been altered from a prior state, based on a comparison of any generated hash(es) of the data in a current state to any generated hash(es) of data in the prior state.

In various embodiments, validating component 350 can also determine whether transactions are valid based on whether a transaction of a digital token or value subject to the transaction is associated with the public key associated with the sender of the transaction. That is, a digital token or value can only be transferred if the blockchain shows that it is stored in or associated with the public key of the sender. If the blockchain shows that the digital token was already transferred, then the validating component 350 can determine that the transaction to transfer the digital token is invalid.

In various embodiments, block generating component 360 can generate blocks of transactions that have been validated by all nodes of the distributed ledger network 100. In some embodiments, a block can be generated by a node if a correct “nonce” is guessed for a set of validated transactions selected by the node for inclusion into a block. This particular process is also called “mining,” and is common to proof-of-work systems. In some other embodiments, a block can be generated by a node if a group of designated nodes are programmed under a Federated Byzantine Agreement, which defines the group of designated nodes as being those that are authorized to generate new blocks. It is contemplated that any technique for block generation by the nodes 110n is within the purview of the present disclosure, and the process of generating blocks is not necessarily limited to one consensus methodology known to one of ordinary skill. If some blockchain systems, such as Ethereum, the generation of a block by a node can generate new tokens (e.g., Ether) for the node responsible for guessing the appropriate “nonce.” However, it is important to distinguish the tokens generated for the particular blockchain employed by the embodiments described herein, and the digital tokens generated for the real-world asset, which are the subject of the present disclosure. Certain blockchains, such as Ethereum, provide a framework where smart contracts can be employed to generate new tokens that are distinguishable from the primary blockchain token (e.g., Ether). With regards to Ethereum, as an example, the Ethereum blockchain is maintained by the nodes to maintain the Ethereum blockchain as a whole, but the Ethereum blockchain can also facilitate the transacting of child tokens (e.g., ERC20 tokens) generated on top of the Ethereum blockchain. In this regard, in some embodiments, a pre-existing and highly secure public blockchain, such as Ethereum, can be employed as a framework on which digital tokens (e.g., ERC20) corresponding to real-world assets can be generated and transferred.

Smart contract component 360 can employ one or more processors (not shown) of the node 110n to execute logic or code programmed into a transaction (e.g., a smart contract) stored on the blockchain. In various embodiments, the smart contract component 360 can determine whether a smart contract's defined conditions precedent have been satisfied. The determination can be performed based on transactions stored on the blockchain, by way of example. As each node receives every validated transaction for storage onto its local copy of the blockchain, the node can analyze an incoming transaction including a smart contract, determine whether past or future transactions include data or triggers that meet the defined conditions precedent, and execute an operation programmed in the smart contract based on the determination that the defined conditions precedent have been meet.

In various embodiments, the smart contract component 360 can reference a token generation smart contract. The token generation smart contract can be associated with the generation of digital tokens corresponding to the real-world assets described herein. In this regard, the node 110n can receive a transaction that includes a request to generate a new digital token corresponding to a real world asset, whereby the transaction is digitally signed with a private key of an associated public key from which the transaction was sent. The received transaction can be addressed to a smart contract address corresponding to the smart contract. In this way, when the transaction including the request and addressed to the smart contract is received, it is associated with the smart contract and the node 110n is made aware of the defined conditions precedent. The token generation smart contract can include, among other things, a set of data fields that can be defined by the received transaction including the request. The data fields can be populated with the requestor's public key, and any metadata also included with the request. Metadata can include, among other things, an identifier of the real-world asset generating device, an identifier of the requestor, a location identifier of the requestor and/or real-world asset generating device, a time stamp, a requested amount or value of digital token(s), and/or any combination of the foregoing, among other things.

The smart contract component 370 can further determine if other transactions stored on the blockchain and also addressed to the token generation smart contract include an approval or denial to the request included in the earlier-received transaction. The other transactions can include a reference to the earlier-received transaction, a reference to the request (e.g., if associated with a request identifier), and a defined approval or denial to the request. The smart contract component 370 can determine whether each of the other transactions is digitally-signed with a private key of a set of known private keys. More specifically, the smart contract component 370 can employ the validating component 350 to determine that one of a set of known public keys, stored in the token generation smart contract, is associated with a transaction approving or denying the request. As described with respect to validating component 350, the cryptography component 340 can employ aspects of asymmetric cryptography to validate the transaction as being digitally-signed with an owner of one of the privileged public keys stored in the smart contract. The token generation smart contract can execute and generate a new token for association with the public key of the digital token requesting transaction, based on a determination that each of the public keys stored therein is associated with a digitally-signed and validated transaction stored on the blockchain, approving the generation of the requested digital token. In various embodiments, the token generation smart contract can include different logic or code to execute and generate the digital token based on varying rules encoded therein, such as whether a more than half of the public keys stored in the smart contract were employed to approve the digital token generation, or the like.

The smart contract component 370 can, based on a determination that each of a set of privileged public keys stored in the smart contract are associated with transactions approving the requested generation of the digital token, execute code or logic that generates or “mints” a new digital token associated with the public key of the requesting transaction. In some embodiments, the newly generated digital token can include metadata that is defined by the smart contract. For instance, the metadata can include a timestamp of generation, approving entities (e.g., public keys of the approving entities), limitations of the digital token, or other characteristics that can uniquely identify the digital token generated. Once generated, the blockchain can reflect the transaction including the generation of the digital token, and the transfer of the generated digital token from the token generation smart contract to the public key associated with the requesting entity.

In some embodiments, the node 110 can include a wallet component 370. Typically, the wallet component 380 is included in client devices, such as privileged clients 230B or unprivileged clients 230A, also operating as a node. Generally speaking, the wallet component 370 can be employed to securely store a private key associated with an entity, generate public keys associated with the private key and also the entity, and also to generate new transactions that are digitally-signed with the stored private key. In some embodiments, the wallet component 370 can monitor a locally or remotely-stored copy of the blockchain for transactions associated with a generated public key, and present a parsed set of transactions that are only associated with the generated public key. The wallet component 370 can generally provide a user-friendly interface for users or entities to identify transactions that are of interest to them (i.e., associated with their public keys). It is further contemplated that in some embodiments, server 240 of FIG. 2 can include a wallet component 380 that stores the private keys of any privileged entities in accordance with embodiments described herein. In this regard, the server 240 can include a node 110n that maintains a local copy of the blockchain, and the server 240 can automatically generate request approval or request denial transactions on behalf of the privileged entities based on rules defined therein. As such, the wallet component 380 of server 240 can store therein a private key for each of the privileged entities, and generate a transaction sent from a corresponding public key (also stored in the token generation smart contract) of the privileged entity to approve or deny requests stored on the blockchain.

Turning now to FIG. 4, a block diagram 400 is provided depicting an exemplary renewable energy generator 235 in accordance with some embodiments of the present disclosure. In various embodiments, the renewable energy generator 235 can be any real-world asset generating device, though a renewable energy generator 235 is provided as an exemplary real-world asset generating device in accordance with FIG. 2. The renewable energy generator can include a memory 410, a communications component 420, and an asset generation metering module 430, among other things. The memory 410 can include a cache, a storage device, or any other computer memory operable to store temporarily or permanently a measured reading of a real-world asset being generated by the renewable energy generator 235. The communications component 420 can be an interfacing module, such as a serial port, USB port, wireless communications device, modem, or other I/O port that can couple the renewable energy generator 235 to an unprivileged client device, such as unprivileged client device 230A of FIG. 2. The asset generation metering module 430 can monitor measurable readings of the real-world asset being generated. By way of example, the asset generation metering module 430 can include an electricity metering module that measures how many units (e.g., kilowatts) of electricity is being generated by the renewable energy generator 235. The measured units of the real-world asset (e.g., electricity) generated by the renewable energy generator 235 can be stored to the memory 410 and/or communicated to a receiving client device, such as unprivileged client device 230A of FIG. 2, via the communications component 420.

Looking now to FIG. 5, a block diagram 500 is provided depicting an exemplary unprivileged client 230A in accordance with the present disclosure. The unprivileged client 230A is generally associated with an unprivileged entity, or in other words, an entity that is requesting the generation of a digital token corresponding to a real-world asset, but does not have authority to generate the digital token without the authorization of privileged entities. The unprivileged client 230A can be coupled to a real-world asset generator, such as renewable energy generator 235 of FIG. 4, to receive measured readings of a real-world asset being generated thereby. The unprivileged client 230A can include a memory 510 for storing the measured readings and any other data received or generated by the unprivileged client 230A. The communications component 520 can be employed by the unprivileged client 230A to communicate with the real-world asset generator, and any nodes of a distributed ledger network, such as distributed ledger network 100 of FIG. 1. In some embodiments, the unprivileged client 230A can include or operate as a node, such as node 110n of FIG. 3, or can include some components thereof. For instance, the unprivileged client 230A can include a wallet component 530 for storing an associated private key, generating associated public key(s), generating transactions from an associated public key, and digitally-signing transactions with the associated private key. In various embodiments, the wallet component 530 can employ the communications component 520 to communicate with one or more other nodes of the distributed ledger network. Communications can include sending transactions, receiving transactions, and/or performing functions of a node as described in accordance with FIG. 3.

In various embodiments, unprivileged client 230A can include an asset tokenizing module 540 having a generated asset detection component 550, a token request generating component 560, and a transaction signing component 570. The asset tokenizing module 540 is generally responsible for requesting the generation of a digital token that corresponds to a real-world asset generated by a real-world asset generating device coupled to the unprivileged client 230A. The generated asset detection component 550 can receive, via communications component 520, the units of the real-world asset (e.g., electricity) generated by the renewable energy generator 235 of FIG. 4, to determine that a unit of the real-world asset has been generated. In some embodiments, the unit can be predefined as a quantifiable unit (e.g., 1 kilowatt) so that when the quantifiable unit is determined generated by the generated asset detection component 550 based on communications from the renewable energy generator 235, the asset tokenizing module 540 can employ token request generating component 560 to generate a new transaction including a request to generate a corresponding digital token. In some embodiments, the token request generating component 560 can generate a new transaction having the request included therein. The generated transaction can be addressed from a public key associated with the unprivileged client 230A and stored in wallet component 530, and can be addressed to a defined token generation smart contract, such as described in FIG. 3. Among other things, the generated transaction can include information that is unique to the unprivileged client 230A and/or the renewable energy generator 235. The asset tokenizing module 540 then employ the transaction signing component 570 to digitally-sign the generated transaction with the stored private key associated with the unprivileged client 230A. In this way, the generated transaction is verifiably communicated from the unprivileged client 230A, via the communications component 520, to the distributed ledger network for storage onto the blockchain maintained thereby.

Looking now to FIG. 6, a block diagram 600 is provided depicting an exemplary privileged client 230B in accordance with the present disclosure. The privileged client 230B is generally associated with a privileged entity, such as a regulatory body, an auditor, an electric company, a government agency, or other entity that is required to authorize the generation of a digital token corresponding to a generated real-world asset described in accordance with the present disclosure. Like the unprivileged client 230A of FIG. 5, the privileged client 230B can include a memory 610, a communications component 620, and a wallet component 630, and can also include or operate as a node or include components thereof. The privileged client 230B can also include a privileged authorization module 640 for generating approval or denial transactions to transactions including requests for digital token generation, such as the transaction generated by unprivileged client 230A of FIG. 5.

In various embodiments, privileged authorization module 640 can include a request detection component 650, a request authorization component 660, and a transaction signing component 670, among other things. The request detection component 650 can query or monitor the blockchain being maintained by the nodes, such as nodes 110n of FIG. 2, and determine whether a transaction including a request to generate a new digital token corresponding to a real-world asset is pending approval. The request detection component 650 can parse the blockchain to identify any new (or previous) transaction(s) that are addressed to a defined token generation smart contract, as described in accordance with FIG. 3, and determine whether the identified transaction(s) are pending a decision on whether a digital token corresponding to a real-world asset should be generated. Based on determining that a transaction is pending a decision, the privileged authorization module 640 can employ the request authorization generating component 660 to generate a new transaction that includes an indication of approval or denial to the request. In some aspects, the generated transaction can include additional information provided by the privileged entity approving the transaction, such as metadata to be included into a digital token generated based on a determined consensus of the privileged entities. Based on the transaction being generated, the transaction signing component 670 can employ a private key associated with the privileged client 230B, to digitally sign the transaction, indicating that it is verifiably generated by the privileged entity or privileged client 230B thereof. The privileged client 230 can then communicate the digitally signed transaction, via the communications component 620, to the distributed ledger network for storage onto the blockchain maintained thereby. In some aspects, and while not shown, the server 240 of FIG. 2 can include a privileged authorization module 640 that performs the above-described features on behalf of one or more privileged entities described in accordance with the present disclosure. In this regard, the server 240 can generate a plurality of approval or denial transactions automatically, on behalf of the one or more privileged entities, based on a predefined set of rules that apply to requests determined to be stored on the blockchain and pending a decision by a consensus of the privileged entities.

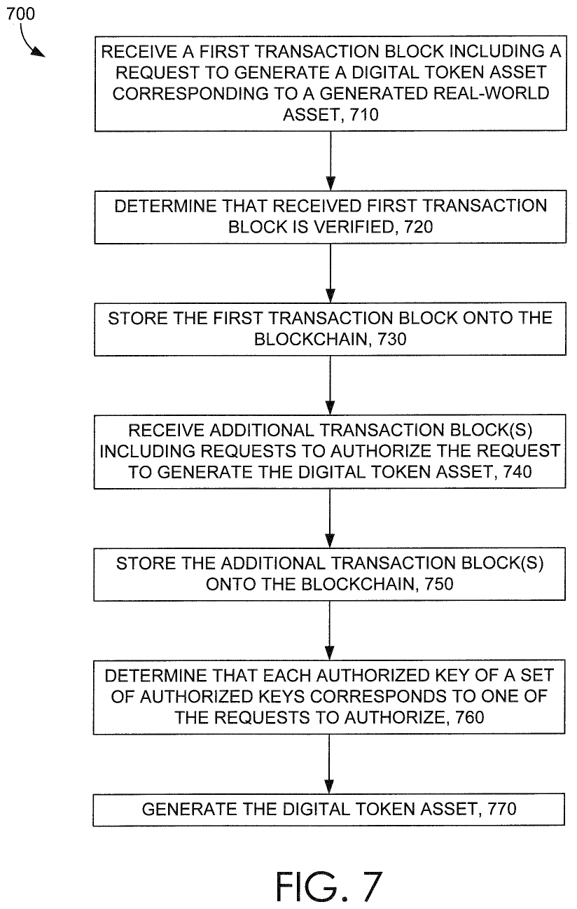

Turning now to FIG. 7, a flow diagram 700 is provided that illustrates a method for generating a digital token asset that corresponds to a generated real-world asset, in accordance with some embodiments of the present disclosure. At step 700, a node, such as node 100n of FIG. 3, can receive a first transaction, or a first transaction block including the first transaction, whereby the first transaction includes a request to generate a digital token asset corresponding to a generated real-world asset. At step 720, the node can determine that the received first transaction or first transaction block is verified. It is contemplated that any variety of consensus rules can be employed to determine the verification status of a transaction or transaction block described herein. At step 730, the node can store the first transaction or first transaction block onto a locally-stored copy of the blockchain being maintained by all nodes in the distributed ledger network in which the node is participating, based on a determination that the first transaction block including the first transaction is verified by the consensus of the nodes.

At step 740, the node can receive additional transactions or additional transaction blocks that include the additional transactions. Each additional transaction can include, among other things, a request to authorize the request to generate the digital token asset. Based on a determination that each additional transaction or transaction block is verified under consensus rules, the node can store, at step 750, the additional transaction blocks including the additional transactions onto the locally-stored copy of the blockchain.

At step 760, the node can determine that each authorized key of a set of authorized key stored in a smart contract to which the requesting transaction and the authorizing transactions are addressed, corresponds to one of the set of authorizing transactions. That is, each authorizing transaction is digitally signed and addressed from one of a set of authorized public keys stored in a smart contract for generating a new digital token corresponding to a real-world asset. At step 770, the node can execute the smart contract to generate a digital token corresponding to the real-world asset, thereby generating a new transaction that associates the generated digital token with the public key from which the request to generate the digital token was addressed. In this way, a digital token corresponding to a real-world asset can be generated on a blockchain based on a consensus-based authorization framework described in accordance with the present disclosure.

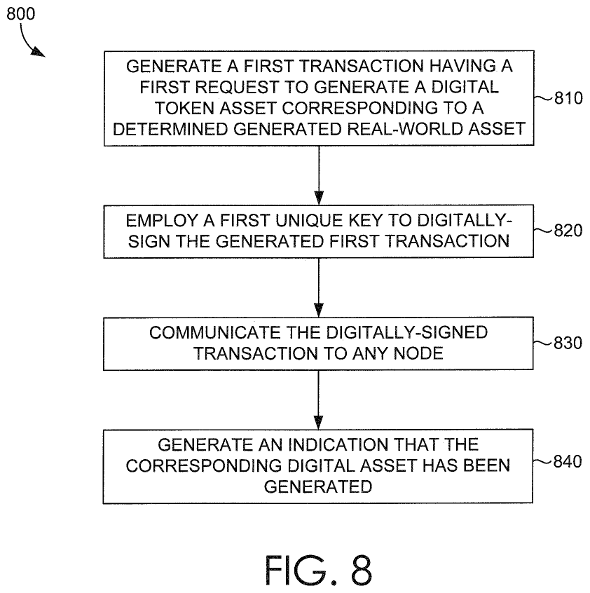

Referring now to FIG. 8, a flow diagram 800 is provided that illustrates a method for requesting the generation of a digital token asset that corresponds to a generated real-world asset, in accordance with some embodiments of the present disclosure. At step 810, a computing device, such as unprivileged client 230A of FIG. 5 and coupled to a real-world asset generator, such as renewable energy generator 235 of FIG. 4, can generate a first transaction having a first request to generate a digital token asset corresponding to a determined generated real-world asset. The computing device can determine that the real-world asset is generated based on measured readings received from the real-world asset generator. At step 820, the computing device can employ a private key associated therewith to digitally sign the generated first transaction, thereby authorizing the generation of the transaction on behalf of an entity associated with the computing device. At step 830, the computing device can communicate the digitally-signed transaction including the request from a public key associated with the private key to any node of a plurality of nodes, such as nodes 110n of FIG. 2, maintaining a distributed ledger on which digital tokens corresponding to real-world assets is recorded. The computing device, at step 840, can include a digital token wallet, such as wallet component 530, to determine that the blockchain includes a transaction that associates a newly-generated digital token to the public key from which the request to generate the digital token was sent. In this way, the computing device can generate a request to generate a digital token corresponding to a determined generated real-world asset, and present an indication (e.g., a GUI alert, audible alert, or other presentable notification) that the digital token was successfully generated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

Having described embodiments of the present invention, an exemplary operating environment in which embodiments of the present invention may be implemented is described below in order to provide a general context for various aspects of the present invention. Referring initially to FIG. 9 in particular, an exemplary operating environment for implementing embodiments of the present invention is shown and designated generally as computing device 900. Computing device 900 is but one example of a suitable computing environment and is not intended to suggest any limitation as to the scope of use or functionality of the invention. Neither should the computing device 900 be interpreted as having any dependency or requirement relating to any one or combination of components illustrated.

With reference to FIG. 9, computing device 900 includes a bus 910 that directly or indirectly couples the following devices: memory 912, one or more processors 914, one or more presentation components 916, input/output (I/O) ports 918, input/output components 920, and an illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 9 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer-storage media in the form of volatile and/or nonvolatile memory. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. The I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be equipped with depth cameras, such as stereoscopic camera systems, infrared camera systems, RGB camera systems, touchscreen technology, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

As can be understood, embodiments of the present invention provide for, among other things, a consensus-based authorization framework for generating digital tokens corresponding to determined generated real-world assets utilizing distributed ledger technologies. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A computer-implemented method for generating digital token assets, the method comprising:
storing, by a node of a distributed plurality of nodes, a received first transaction block onto a local copy of a blockchain maintained at least in part by the node, the received first transaction block including a first transaction that is digitally signed with a first unique key associated with a real-world asset generating device, wherein the first transaction includes a first request to generate a digital token asset that corresponds to a generated real-world asset;
receiving, by the node, a set of second transaction blocks including a set of second transactions, each second transaction in the set of second transactions being digitally signed with one of a set of second unique keys authorized to approve the first request, and including a corresponding second request to approve the first request; and
generating, by the node, the corresponding digital token asset based on a determination that the local copy of the blockchain includes the set of digitally signed second transactions, and that each second unique key in the set of second unique keys corresponds to one of the digitally signed second transactions.

2. The computer-implemented method of claim 1, wherein the received first transaction block is stored based at least in part on a determination that a consensus of the distributed plurality of nodes has verified the received request.

3. The computer-implemented method of claim 2, wherein the set of digitally signed second transactions is stored on the local copy of the blockchain based at least in part on one or more other determinations that the consensus of the distributed plurality of nodes has verified each second transaction block in the set of second transaction blocks.

4. The computer-implemented method of claim 1, wherein the first transaction block or any second transaction block of the set of second transaction blocks is received from any other node of the distributed plurality of nodes.

5. The computer-implemented method of claim 1, further comprising:
storing, by the node, the generated digital token asset onto the local copy of the blockchain.

6. The computer-implemented method of claim 1, wherein the set of second unique keys is associated with a smart contract stored on the blockchain.

7. The computer-implemented method of claim 6, wherein the node employs the smart contract to generate the digital token asset.

8. The computer-implemented method of claim 1, wherein the generated digital token asset includes a unique identifier and metadata that corresponds at least in part to the real-world asset generating device.

9. The computer-implemented method of claim 1, wherein the generated digital token asset is associated with the first unique key.

10. The computer-implemented method of claim 1, wherein the real-world asset generating device includes a renewable energy generator, and wherein the real-world asset corresponds to a defined unit of energy.

11. A non-transitory computer storage medium storing computer-useable instructions that, when used by one or more computing devices, cause the one or more computing devices to perform operations comprising:
generating, by a computing device coupled to a real-world asset generating device, a first transaction that includes a first request to generate a digital token asset that corresponds to a real-world asset determined to be generated by the real-world asset generating device;
employing, by the computing device, a first unique key associated with one of the computing device or the real-world asset generating device to digitally sign the generated first transaction;
communicating, to any node of a distributed plurality of nodes that collectively maintain a blockchain, the digitally-signed first transaction; and
generating, by the computing device, an indication that the corresponding digital token asset has been generated based on a determination that a node of the distributed plurality of nodes includes a stored copy of the blockchain, that the blockchain includes a set of digitally-signed second transactions, and that each second unique key in a set of second unique keys authorized to approve the first request corresponds to one of the digitally-signed second transactions in the set of digitally-signed second transactions.

12. The non-transitory computer storage medium of claim 11, wherein the set of second unique keys is associated with a smart contract stored on the blockchain.

13. The non-transitory computer storage medium of claim 11, wherein the generated digital token asset includes a unique identifier and metadata that corresponds at least in part to the real-world asset generating device.

14. The non-transitory computer storage medium of claim 11, wherein the generated digital token asset is associated with the first unique key.

15. The non-transitory computer storage medium of claim 11, wherein the real-world asset generating device includes a renewable energy generator, and wherein the real-world asset corresponds to a defined unit of energy.

16. A computerized system for generating digital token assets, comprising:
a node of a distributed plurality of nodes for:
storing a received first transaction block onto a local copy of a blockchain maintained at least in part by the node, the received first transaction block including a first transaction that is digitally signed with a first unique key, wherein the first transaction includes a first request to generate a digital token asset that corresponds to a generated real-world asset;
receiving a set of second transaction blocks including a set of second transactions, each second transaction in the set of second transactions being digitally signed with one of a set of second unique keys authorized to approve the first request, and including a corresponding second request to approve the first request; and
generating the corresponding digital token asset based on a determination that the local copy of the blockchain includes the set of digitally signed second transactions, and that each second unique key in the set of second unique keys corresponds to one of the digitally signed second transactions.

17. The computerized system of claim 16, wherein the generated digital token asset is associated with the first unique key.

18. The computerized system of claim 16, further comprising:
a real-world asset generating device for generating the real-world asset, wherein the real-world asset generating device is associated with the first unique key.

19. The computerized system of claim 16, wherein the real-world asset generating device includes a renewable energy generator, and wherein the real-world asset corresponds to a defined unit of energy.

20. The computerized system of claim 18, further comprising:
a computing device coupled to the real-world asset generating device for:
determining that the real-world asset was generated by the real-world asset generating device;
generating the first transaction based on the determination that the real-world asset was generated by the real-world asset generating device;
employing the first unique key to digitally sign the generated first transaction;
communicating, to any node of the distributed plurality of nodes, the digitally-signed first transaction; and
generating an indication that the corresponding digital token asset has been generated based on the determination that the local copy of the blockchain includes the set of digitally signed second transactions, and that each second unique key in the set of second unique keys corresponds to one of the digitally signed second transactions.
